(19) United States
(12) Patent Application Publication
(10) Pub. No.: US 2004/0024827 A1
(43) Pub. Date: Feb. 5, 2004

(54) Two way e-mail system and recording medium

(76) Inventor: Masako Yoshimura, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 10/389,781

(22) Filed: Mar. 18, 2003

(30) Foreign Application Priority Data
Mar. 20, 2002 (JP) 2002-078392

(51) Int. Cl. G06F 15/16

(52) U.S. Cl. 709/206

(57) ABSTRACT

A two way e-mail system of the invention comprises an outbound data generator for generating an outgoing data according to a prescribed format when sending a mail, an incoming data analyzer for analyzing an incoming data when a mail is received, a mail data manager for managing mail data, a mail data storage for storing the mail data, a mail display processor for controlling a process of displaying the mail, a password authentication processor for authenticating a password, an address data manager for managing address directory data, an address data storage for storing the address directory data, a display unit for displaying the mail data and the like, and controller for controlling the outbound data generator, the incoming data analyzer, the mail data manager, the mail display processor, the password authentication processor and the address data manager, and also controlling a flow of the data stored in the mail data storage and the address data storage, and that the password authentication processor examines and authenticates the password when an address data corresponding to a mail text directed to be displayed is stored in the address data storage and the password is set thereto.

### FIELD OF THE INVENTION

The present invention relates to a two way e-mail system capable of handling electronic mails and the like data transmitted and received via the Internet and the like, and a recording medium for executing a process thereof.

### BACKGROUND OF THE INVENTION

It is required to have information of a mail account and a password in order to connect a personal computer with a mail server and to transmit and receive electronic mails. When an individual has a mail account of his/her own, mails being transmitted and received by this individual are protected by the password, and contents of the mails may not be readable by any person without knowing the password.

However, as the diversification of devices capable of transmitting and receiving electronic mails continues to increase along with popularization of the Internet in recent years, there are circumstances in which single unit of terminal device is shared by a plurality of people within a family and in office, instead of it being used exclusively by one individual.

Certain data terminals of such kind are not adaptable to setting of more than one mail account due to the functional limitation, and they require a plurality of people to use the same mail account. Or, even if a terminal is capable of accepting more than one mail account, the device is often used by a plurality of people sharing one mail account in an ordinary family for economical reason and the like.

When a plurality of people share one mail account in this manner, every user who uses the same mail account can gain access to all transmitted and received mails due to the conventional mail transmission and receiving function of the personal computer, thereby giving rise to a problem because personal mails can be read by other people.

Therefore, there is an increased demand for two way e-mail system and recording media of this kind to have a protective function for personal mails that makes specific mails not accessible to other users who use the same mail account.

### SUMMARY OF THE INVENTION

The present invention is intended to provide a two way e-mail system capable of maintaining certain mails inaccessible to other users who use a same mail account by way of referring to an address directory data stored in the two way e-mail system, and a recording medium storing a program for executing the aforesaid function in the two way e-mail system.

The two way e-mail system of the present invention comprises an outbound data generator for generating an outgoing data according to a prescribed format when sending a mail, an incoming data analyzer for analyzing an incoming data when a mail is received, a mail data manager for managing mail data, a mail data storage for storing the mail data, a mail display processor for controlling a process of displaying the mail, a password authentication processor for validating a password, an address data manager for managing address directory data, an address data storage for storing the address directory data, a display unit for displaying the mail data and the like, and controller for controlling the outbound data generator, the incoming data analyzer, the mail data manager, the mail display processor, the password authentication processor and the address data manager, and also controlling a flow of the data stored in the mail data storage and the address data storage. The password authentication processor examines and authenticates a password when an address data corresponding to a mail text directed to be displayed is stored in the address data storage and the password is set thereto.

### BRIEF DESCRIPTION OF THE DRAWINGS

FIG. 1 is a functional block diagram showing a two way e-mail system according to a first exemplary embodiment of the present invention.

FIG. 2 is a structural diagram of concrete hardware depicting the two way e-mail system according to the first exemplary embodiment of the invention.

FIG. 3 is an illustration showing an example of display screen for editing an address data in the two way e-mail system according to the first exemplary embodiment of the invention.

FIG. 4 is a data table showing an example of address data stored in address data storage of the two way e-mail system according to the first exemplary embodiment of the invention.

FIG. 5 is a flow chart showing an operation of the two way e-mail system according to the first exemplary embodiment of the invention.

FIG. 6 is a flow chart showing an operation of a two way e-mail system according to a second exemplary embodiment of the invention.

FIG. 7 is a data table showing an example of a received mail list in the two way e-mail system according to the second exemplary embodiment of the invention.

FIG. 8 is an illustration showing an example of display screen for editing an address data in a two way e-mail system according to a third exemplary embodiment of the invention.

FIG. 9 is an illustration showing an example of display screen for registering an address management group in the two way e-mail system according to the third exemplary embodiment of the invention.

FIG. 10 is a flow chart showing an operation of the two way e-mail system according to the third exemplary embodiment of the invention.

FIG. 11 is a functional block diagram showing a two way e-mail system according to a fourth exemplary embodiment of the invention.

FIG. 12 is an illustration showing an example of display screen for editing an address data in the two way e-mail system according to the fourth exemplary embodiment of the invention.

FIG. 13 is an illustration showing an example of display screen for registering a user in the two way e-mail system according to the fourth exemplary embodiment of the invention.

FIG. 14 is a flow chart showing an operation of the two way e-mail system according to the fourth exemplary embodiment of the invention.

FIG. 15 is a flow chart showing an operation of a two way e-mail system according to a fifth exemplary embodiment of the invention.

FIG. 16 is another flow chart showing an operation of the two way e-mail system according to the fifth exemplary embodiment of the invention.

FIG. 17 is a flow chart showing an operation of a two way e-mail system according to a sixth exemplary embodiment of the invention.

FIG. 18 is a functional block diagram showing a two way e-mail system according to a seventh exemplary embodiment of the invention.

FIG. 19 is a structural diagram of concrete hardware depicting the two way e-mail system according to the seventh exemplary embodiment of the invention.

FIG. 20 is an illustration showing an example of display screen for editing an address data in the two way e-mail system according to the seventh exemplary embodiment of the invention.

FIG. 21 is a data table showing an example of address data in the two way e-mail system according to the seventh exemplary embodiment of the invention.

FIG. 22 is a flow chart showing an operation of the two way e-mail system according to the seventh exemplary embodiment of the invention.

### DETAILED DESCRIPTION

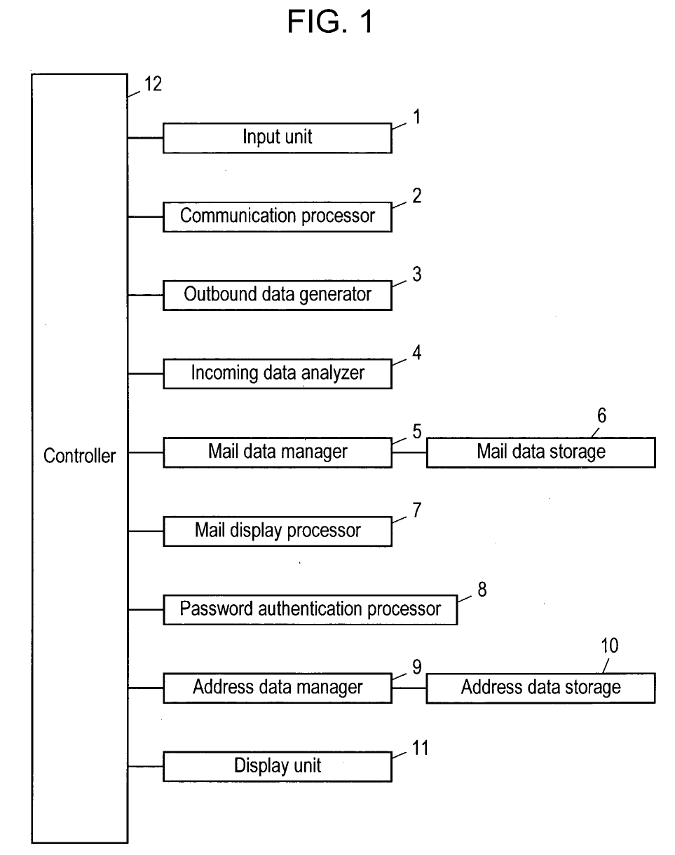

Referring to FIG. 1 through FIG. 22, exemplary embodiments of the present invention will be described hereinafter.

(First Exemplary Embodiment)

FIG. 1 is a functional block diagram showing a two way e-mail system according to the first exemplary embodiment of this invention. The two way e-mail system is a device that both transmits and receives analog or digital signals.

The two way e-mail system comprises input unit 1 for entering an input of instruction given by a user, communication processor 2 for exchanging data with a network and the like, outbound data generator 3 for generating an outgoing data according to a prescribed format when transmitting a mail, incoming data analyzer 4 for analyzing an incoming data when a mail is received, mail data manager 5 for managing mail data, mail data storage 6 for storing the mail data, and mail display processor 7 for controlling a process of displaying the mail.

The two way e-mail system further comprises password authentication processor 8 for authenticating a password, address data manager 9 for managing data in an address directory, address data storage 10 for storing the address data, and display unit 11 for displaying the mail data and the like. Controller 12 controls individual functions of communication processor 2, outbound data generator 3, incoming data analyzer 4, mail data manager 5, mail display processor 7, password authentication processor 8 and address data manager 9 as well as interrelated operation between them. The controller 12 also controls a flow of data stored in mail data storage 6 and address data storage 10.

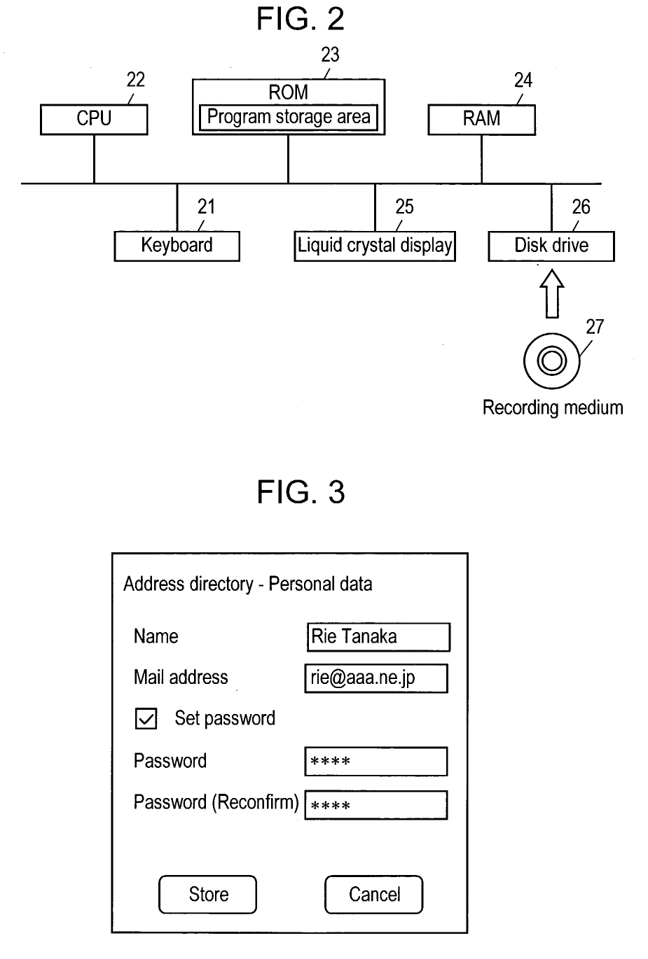

FIG. 2 is an architectural diagram of concrete hardware depicting the two way e-mail system of FIG. 1, and it shows keyboard 21, central processing unit (“CPU”) 22, read-only memory (“ROM”) 23, random access memory (“RAM”) 24, liquid crystal display 25 and disk drive 26 for reading data from recording medium 27 such as a CD-ROM.

The input unit 1 shown in FIG. 1 is materialized with keyboard 21, and the mail data storage 6 and the address data storage 10 are materialized with RAM 24. Input panel can be used as the input unit 1 instead of the keyboard.

Furthermore, the communication processor 2, outbound data generator 3, incoming data analyzer 4, mail data manager 5, mail display processor 7, password authentication processor 8, address data manager 9 and controller 12 are materialized with the CPU 22, which executes a control program stored in the ROM 23 while exchanging data with the ROM 23 and the RAM 24. In addition, the display unit 11 is materialized with liquid crystal display 25.

In this first exemplary embodiment, although what is shown is a configuration in which the CPU 22 performs the control function by executing the program stored in the ROM 23, it may be configured differently so that the CPU 22 executes the control program stored in the computer-readable recording medium 27 after reading it with disk drive 26 and expanding it in the RAM 24.

The two way e-mail system configured as above operates in a manner which is described hereinafter.

FIG. 3 is an illustration showing an example of display screen for editing an address data, which the address data manager 9 presents on the display unit 11 for a user, when the user enters a command for address registration using input unit 1 in the two way e-mail system of this exemplary embodiment.

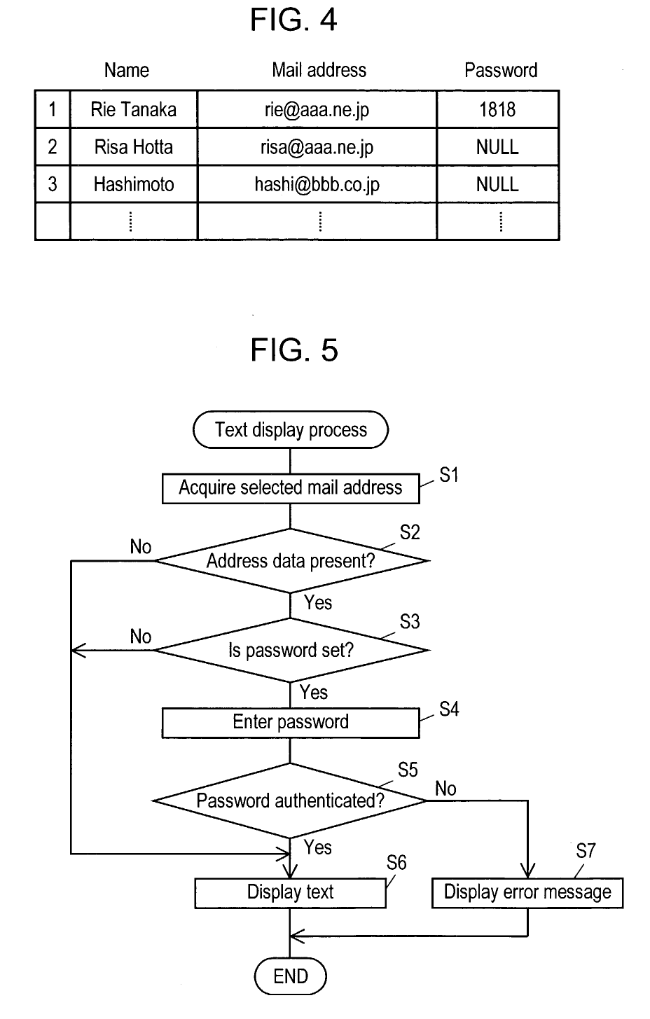

When the user selects “set password” and “store” thereafter in the address data edit screen of FIG. 3, the address data manager 9 stores a password input by the user in the address data storage 10. FIG. 4 is a data table showing an example of address data stored in the address data storage 10.

All received mails (or outbound mails) having addresses for which the password is set cannot be opened unless the password is input correctly by the user. This function applies to all of the following exemplary embodiments.

In the two way e-mail system of the first exemplary embodiment, when the user enters a command to display a mail list using input unit 1, the mail display processor 7 retrieves the data in the mail data storage 6 and displays the mail list in the display unit 11 for review by the user.

FIG. 5 is a flow chart illustrating a process of displaying texts, when the user enters a command to display the texts using the input unit 1.

First, the mail display processor 7 acquires a sender address of a received mail (or, a destination address of an outbound mail), the display process of which text is directed (S1). Next, the mail display processor 7 directs the address data manager 9 to search through the data in the address data storage 10 to find the address acquired in the step S1 (i.e. the sender address of the received mail) (S2). If the same address data as that acquired in the step S1 is stored in the address data storage 10, the process goes on to step S3 to determine presence or absence of a password set in connection with the data.

When there is a password set for the address directory data stored in the address data storage 10, the mail display processor 7 sends a request to the password authentication processor 8 for an input of password (S4). The password authentication processor 8 compares a password input by the user with the password set for the address data. When the password input by the user is verified identical to the password set for the address data, the process of displaying a text goes on to step S6 (S5).

In the step S6, the mail display processor 7 displays text of the designated mail in the display unit 11, and the text display process ends.

If the password input by the user is determined different from the password set for the address data, an error message is displayed instead of the text (S7).

If determination in the step S2 is that the address data storage 10 does not store the same address data as that acquired in the step S1, or if determination in the step S3 is that there is no password set in connection with the address data acquired in the step S2, the mail display processor 7 displays text of the designated mail without requesting input of password, and the text display process ends.

As described above, the password authentication processor 8 authenticates a password only when an address data corresponding to the mail, display of which text is directed, is stored in the address data storage 10, and the password is set for the address data. By requiring password authentication before referring to the mail data transmitted to and/or received from specific parties, it can be made possible to maintain certain mails inaccessible to other users who use the same mail account. In other words, confidentiality protection of personal mails can be accomplished.

(Second Exemplary Embodiment)

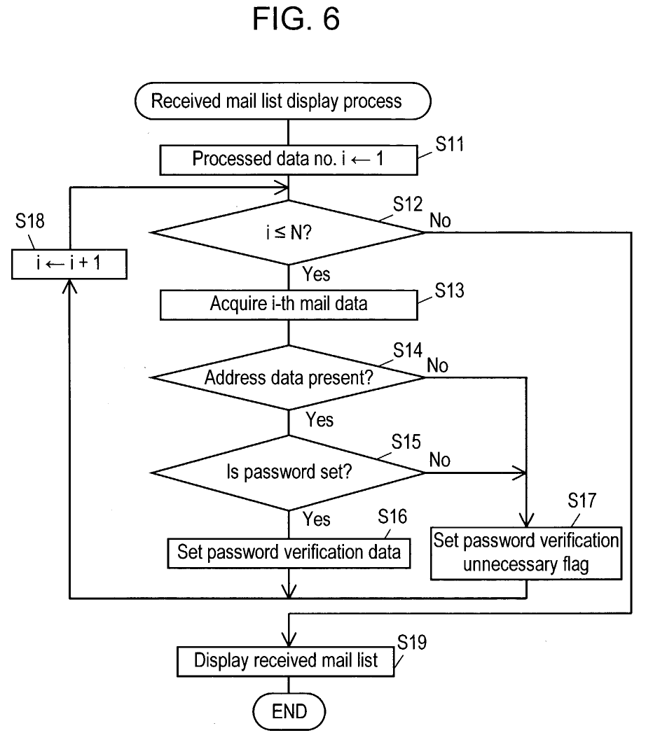

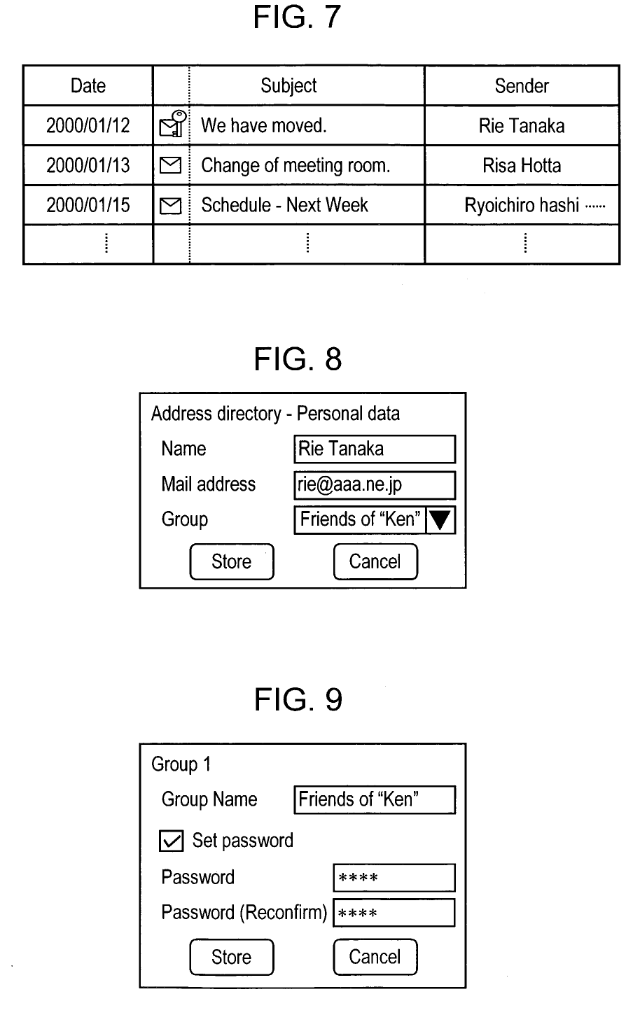

Referring to FIG. 1, FIG. 2, FIG. 6 and FIG. 7, description is now provided of the second exemplary embodiment of this invention.

A two way e-mail system of the second exemplary embodiment is similar to that described in the first exemplary embodiment, as it has the structure shown in FIG. 1 and FIG. 2.

FIG. 6 is a flow chart illustrating a process of displaying a list of received mails when the two way e-mail system of the second exemplary embodiment displays the list of received mails with indications showing individually as to whether or not they are protected by a password. FIG. 7 is a data table depicting an example of the list of received mails in the two way e-mail system according to this exemplary embodiment. This example of the list of received mails shows whether each of them is protected by a password.

In this second exemplary embodiment, although description will be given of the example of displaying the list of received mails, like list can be realized for outbound mails by replacing the sender addresses of the received mails with destination addresses of the outbound mails.

In FIG. 6, mail display processor 7 first initializes processed data number “i” by resetting it to “1” (S11). Next, it is determined whether the processed data number “i” is equal to or less than a number of received mails “N” in mail data storages 6 as referred to by the mail data manager 5 (S12). The process of displaying a list of received mails goes on to the step S13 when the processed data number is judged to be equal to or less than the number of received mails

In step S13, the mail display processor 7 acquires received mail data having data number “i” from the mail data storage 6. Next, the mail display processor 7 directs the address data manager 9 to search through the data in the address data storage 10 to find the sender address of the received mail acquired in the step S13 (S14). If the same data as the sender address is stored in the address data storage 10, the process goes on to determine presence or absence of a password set in connection with the data (S15). When the determination is so made in the step S15 that a password is set for the address data stored in the address data storage 10, the mail display processor 7 sets an address data number to the sender address retrieved in the step S14 as a password verification data corresponding to the received mail data acquired in the step S13 (S16).

The mail display processor 7 sets a password verification unnecessary flag (−1) as the password verification data corresponding to the received mail data acquired in the step S13, if the determination is one of the following two cases (S17). The first case is a determination in the step S14 that the sender address is not stored in the address data storage 10, and the other case is a determination in the step S15 that a password is not set for the address data stored in the address data storage 10. After the password verification data is set, a count of one is added to the processed data number “i” (S18), and the process returns to the step S12 to continue the procedure for the remainder of data.

When the processed data number “i” exceeds the number of received mails “N” in the step S12, the process goes on to step S19. In the step S19, the mail display processor 7 produces a list of the received mails with indications showing individually whether or not they are protected by the password by referring to the password verification data set thereto, displays it in the display unit 11, and this process of displaying the list of received mails ends.

All received mails (or outbound mails) having addresses for which the password is set are not openable unless the password is input correctly by the user, and this function applies to all of the other exemplary embodiments.

As described in this second exemplary embodiment, the mail display processor 7 directs the address data manager 9 to search through the address data in the address data storage 10 to find the sender address of the received mail stored in the mail data storage 6. The mail display processor 7 then sets the password verification data when the address data manager 9 determined that the same data as the sender address is stored in the address data storage 10, and that the password is set for the address data. Afterwards, the mail display processor 7 produces the list of received mails with indications individually showing whether or not they are protected by the password by referring to the password verification data set thereto, and causes the display unit 11 to display it. The invention can thus achieve display of the mail list showing whether each of the mails is protected by the password.

(Third Exemplary Embodiment)

Third exemplary embodiment of this invention will now be described with reference to FIG. 1, FIG. 2, and FIG. 8 through FIG. 10.

A two way e-mail system according to the third exemplary embodiment has like structure as that of the first exemplary embodiment, as shown in FIG. 1 and FIG. 2.

FIG. 8 is an illustration showing an example of display screen for editing address data that address data manager 9 presents on display unit 11 for a user, when the user enters a command for address registration using input unit 1 in the two way e-mail system of this third exemplary embodiment. FIG. 9 illustrates another example of display screen for registration of an address management group, which the address data manager 9 presents to the user on the display unit 11.

Once a group name is registered in the registration screen of FIG. 9 for address management group, the user can record the group name for each of address data to be stored in address data storage 10 by using the address data edit screen of FIG. 8.

After the password is set for the registered group, all of the addresses named in that group are provided with the same effect as in the case of setting the password individually, even though the password is not set for these address data one by one.

In the two way e-mail system of this third embodiment, when the user inputs a command to display a mail list by using the input unit 1, the mail display processor 7 retrieves the data in the mail data storage 6, and displays the requested mail list on the display unit 11.

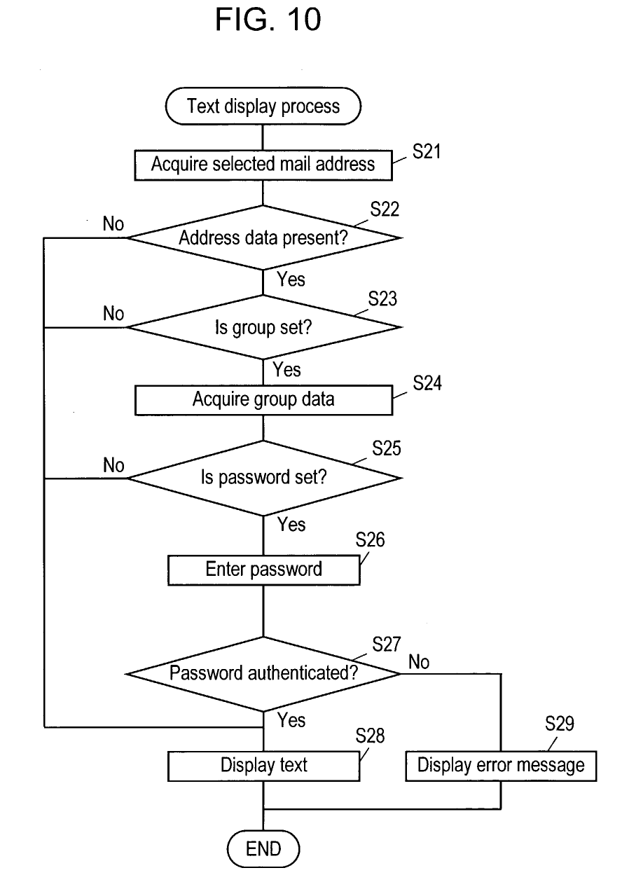

Referring now to a flow chart of FIG. 10, description is provided of a process of displaying text when the user uses the input unit 1 to give a command for displaying the text.

First, the mail display processor 7 acquires a sender address of a received mail (or, a destination address of an outbound mail), the display process of which text is directed (S21). Next, the mail display processor 7 directs the address data manager 9 to search through the data in the address data storage 10 to find the address acquired in the step S21 (i.e. the sender address of the received mail or the destination address of the outbound mail) (S22).

When a determination in the step 22 is that the same address data is stored in the address data storage 10, another determination is made as to whether or not a group is set for the address data (S23).

If the determination is so made that there is a group set for the address data, the address data manager 9 acquires data on the group stored in the address data storage 10 (S24), and determines next as to if a password is set for the acquired group data (S25).

In this instance, all the received mails (or outbound mails) having addresses to which the password is set are not openable unless the password is input correctly by the user, and this function applies to all of the other exemplary embodiments.

When there is a determination that a password is set for the group data, mail display processor 7 makes the password authentication processor 8 request the user to enter the password (S26). The password authentication processor 8 compares the password input by the user with the password set for the group data acquired in the step S24 (S27), and the process of displaying text goes on to step S28 when the password input by the user is authenticated identical to the password set for the group data.

In the step S28, the mail display processor 7 displays text of the designated mail in the display unit 11, and the text display process ends.

If the password input by the user is determined different from the password set for the group data, an error message is displayed instead of the text (S29).

If determination in the step S22 is that the address data storage 10 does not store the address being searched, if determination in the step S23 is that there is no group name set for the address data, or if determination in the step S25 is that there is no password set in connection with the group data in that group, the text display process goes on to the step 28 without requesting entry of a password, and the text display process ends after the mail display processor 7 displays text of the designated mail.

According to the third exemplary embodiment, the mail display processor 7 directs the address data manager 9 to search through the address data in the address data storage 10 to find the sender address of the received mail stored in the mail data storage 6. The mail display processor 7 then makes determination for three conditions that are: 1. whether or not sender address data is stored in the address data storage 10; 2. whether a group is set for the sender address data; and 3. whether a password is set for the group data. Authentication verification of the password, when input by the user, can be made as to whether or not it matches with the password set for the group data only when all of the three conditions stated above are satisfied simultaneously. Mail text of the received mail data is displayed in the display unit 11 when the two passwords match with each other. Texts of the outbound mails can be displayed in the same manner by simply replacing the sender addresses of the received mails with destination addresses of the outbound mails. Accordingly, this embodiment makes possible to maintain certain mails inaccessible to other users who use the same mail account, without requiring a complex operation of setting the password for a plurality of address data, and thereby accomplishing confidentiality protection of personal mails.

(Fourth Exemplary Embodiment)

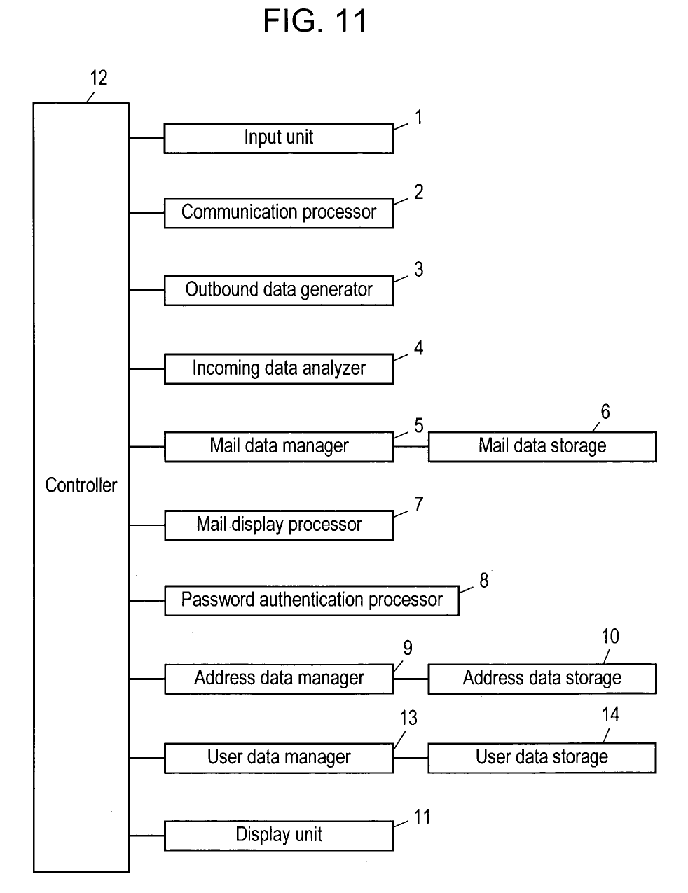

FIG. 11 is a functional block diagram showing a two way e-mail system according to the fourth exemplary embodiment of the present invention.

In FIG. 11, input unit 1, communication processor 2, outbound data generator 3, incoming data analyzer 4, mail data manager 5, mail data storage 6, mail display processor 7, password authentication processor 8, address data manager 9, address data storage 10, display unit 11 and controller 12 are designated by the same reference numerals as those shown in FIG. 1 since they are similar to the corresponding components, and their details are therefore skipped. In addition, FIG. 11 further shows user data manager 13 for managing user data, and user data storage 14 for storing the user data.

Hardware architecture of the two way e-mail system of this fourth exemplary embodiment is also analogous to that of the first exemplary embodiment, and it is represented by FIG. 2.

Here, the input unit 1 shown in FIG. 11 is materialized with keyboard 21, and the mail data storage 6, address data storage 10 and user data storage 14 are materialized with RAM 24. Furthermore, the communication processor 2, outbound data generator 3, incoming data analyzer 4, mail data manager 5, mail display processor 7, password authentication processor 8, address data manager 9, user data manager 13 and controller 12 are materialized with CPU 22, which executes a control program stored in ROM 23 while exchanging data with the ROM 23 and the RAM 24. In addition, the display unit 11 is materialized with liquid crystal display 25.

In this fourth exemplary embodiment, although what is shown is a configuration in which the CPU 22 performs the control function by executing the program stored in ROM 23, it may be configured differently so that the CPU 22 executes the control program stored in computer-readable recording medium 27 after reading it through disk drive 26 and expanding it in the RAM 24.

The two way e-mail system constructed as above operates in a manner which is described hereinafter with reference to the accompanying drawings.

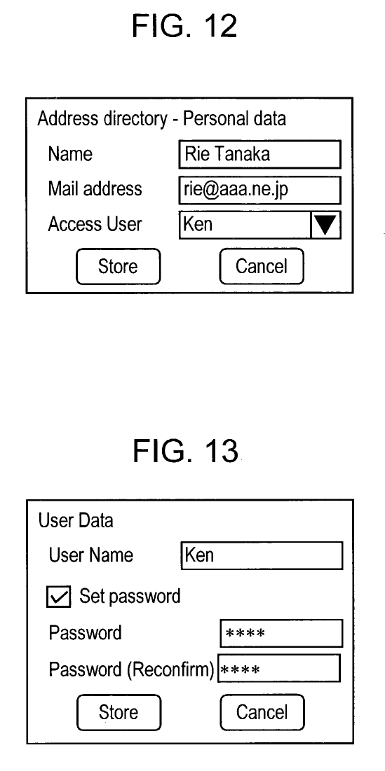

FIG. 12 shows an example of display screen which the address data manager 9 presents on the display unit 11 for a user to edit an address data, when the user enters a command for address registration using the input unit 1 in the two way e-mail system of this exemplary embodiment. Also, FIG. 13 shows an example of display screen for user registration which the address data manager 9 presents to the user on the display unit 11 when the user enters a command for user registration using the input unit 1.

Once the user completes registration of his/her name on the user registration screen of FIG. 13, the user can record the name on the address editing screen of FIG. 12 to designate him/her as only the user who can gain access to individual address data stored in the address data storage 10.

When the user sets a password in the user registration screen of FIG. 13, the user is not required to set the password for every one of the address data to which he/she is designated as the accessible user. As a result, this can give the same effect as the case of setting the password individually.

In the two way e-mail system of the fourth exemplary embodiment, when the user enters a command to display a mail list using the input unit 1, the mail display processor 7 retrieves the data in the mail data storage 6 and displays in the display unit 11 the mail list for the user to review.

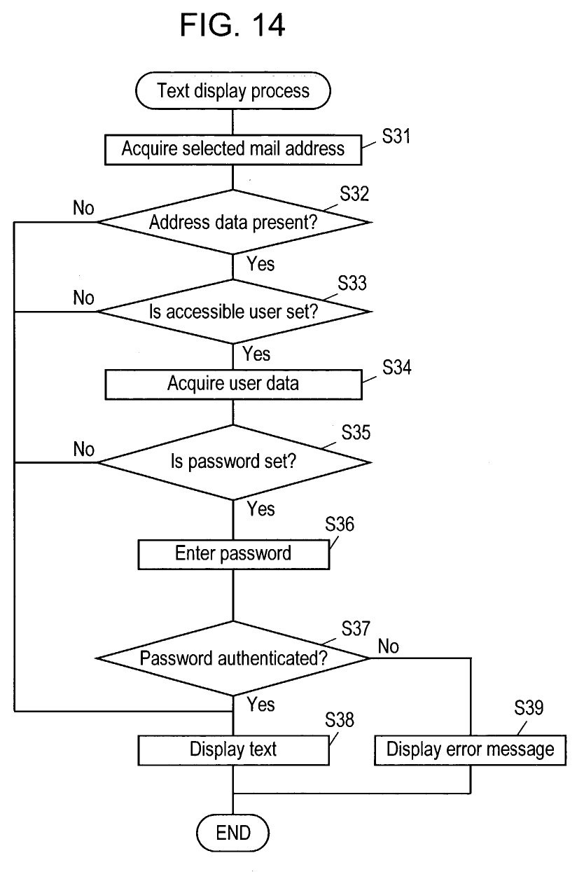

FIG. 14 is a flow chart illustrating an operating process, when the user enters a command to display the texts using the input unit 1.

First, the mail display processor 7 acquires a sender address of a received mail (or, a destination address of an outbound mail), the display process of which text is directed (S31). Next, the mail display processor 7 directs the address data manager 9 to search through the data in the address data storage 10 to find a same address as the one acquired in the step S31 (S32).

When a determination in the step 32 is that the same address data is stored in the address data storage 10, another determination is made in the step 33 as to whether or not an accessible user is set for the address data.

If the determination is so made that there is an accessible user set for the address data, the user data manager 13 acquires a data on the user stored in the user data storage 14 (S34), and determines next as to if a password is set for the acquired user data (S35).

In this instance, all the received mails (or outbound mails) having addresses for which the password is set are not openable unless the password is input correctly by the user, and this function applies to all of the other exemplary embodiments.

When there is a determination that a password is set for the user data, mail display processor 7 makes the password authentication processor 8 request the user to enter the password (S36). The password authentication processor 8 then compares the password input by the user with the password set for the accessible user data and acquired in the step S34 (S37). The process goes on to step S38 when the password input by the user is authenticated identical to the password set for the accessible user data.

In the step S38, the mail display processor 7 displays text of the designated mail in the display unit 11, and the text display process ends.

If, in the step S37, the password input by the user is determined different from the password set for the accessible user data, an error message is displayed instead of the text (S39).

In an event of any one of the following cases (1), (2) and (3), the password authentication processor 8 does not request the user to enter the password, and the text display process ends after displaying text of the designated mail in the step S38: (1) determination in the step 32 is that address data is not found in the address data storage 10; (2) determination in the step 33 is that an accessible user is not designated to the address data; and (3) determination in the step 35 is that a password is not set for the data of accessible user.

A flow of the operating process in the two way e-mail system of the fourth exemplary embodiment is put in order as follows.

First, the mail display processor 7 directs the address data manager 9 to search through the address data in the address data storage 10 to find same data as the sender address data of the received mail data stored in the mail data storage 6. Next, the mail display processor 7 determines: (1) whether the sender address data is stored in the address data storage 10; (2) whether an accessible user data is set for the stored sender address data; and (3) whether a password is set for the access user data set thereto. When all of these conditions are met, and if the input password matches with the password set for the accessible user data, the mail text of the received mail data is displayed in the display unit 11. It is also possible to display text of any outbound mail in the similar manner by replacing the sender address of the received mail with destination address of the outbound mail.

With the above operating process, this embodiment makes possible to maintain certain mails inaccessible to other users who use the same mail account without requiring a complex operation of setting the password for a plurality of address data, and thereby realizing confidentiality protection of personal mails.

(Fifth Exemplary Embodiment)

Fifth exemplary embodiment of this invention will now be described with reference to FIGS. 1, 2, 15 and 16.

A structure of the two way e-mail system of this fifth exemplary embodiment is analogous to that of the first exemplary embodiment, and it is represented by FIG. 1 and FIG. 2.

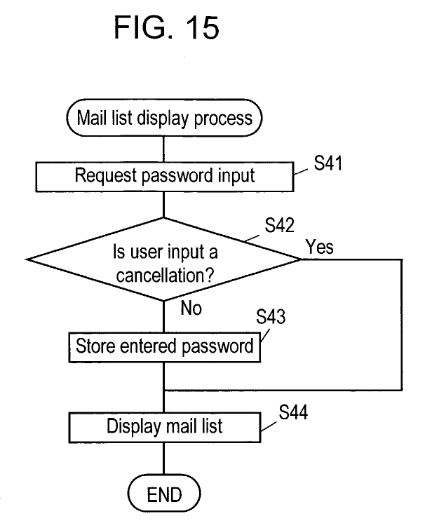

FIG. 15 is a flow chart illustrating an operating process, when a user enters a command to display a mail list using input unit 1.

In FIG. 15, mail display processor 7 directs password authentication processor 8 to request entry of a password (S41). When the password authentication processor 8 determines in step S42 that operation made by the user is not a cancellation of an input, it stores a password input by the user in step S43, and the process goes on to step S44. If the password authentication processor 8 determines that the operation made by the user is a cancellation of the input, it does not store the input password, and the process goes on to the step S44. Therefore, when the user does not think a password is necessary for a mail, he or she can select “a cancellation of the input”. In the step S44, the mail display processor 7 retrieves data in the mail data storage 6, and displays the mail list in the display unit 11. This completes the display process of the mail list.

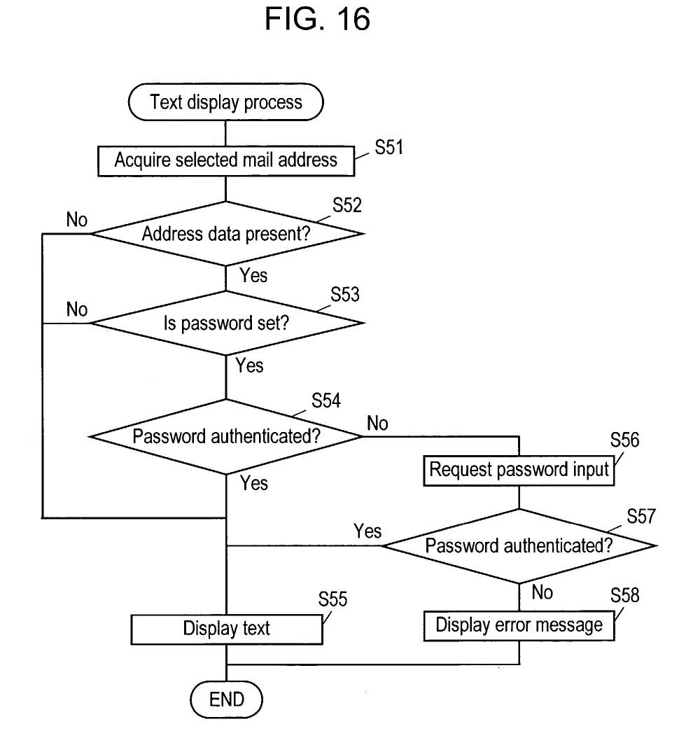

Shown in FIG. 16 is a flow chart illustrating an operation when the user enters a command through the input unit 1 for displaying a text of any mail in the list displayed as a result of the display process discussed above.

First, the mail display processor 7 acquires a sender address of the received mail (or, a destination address of an outbound mail), the display process of which text is directed (S51). Next, the mail display processor 7 directs the address data manager 9 to search through the data in the address data storage 10 to find same address as the one acquired in the step S51 (S52).

When there is a determination that the same address data as the one acquired is stored in the address data storage 10, another determination is made as to whether or not a password is set for the address data (S53).

All received mails (or outbound mails) having addresses to which the password is set cannot be opened unless the password is input correctly by the user. This function applies to all of the other exemplary embodiments.

When the determination is so made in the step S53 that there is a password set for the address data stored in the address data storage 10, the process goes on to step S54.

In the step S54, the password authentication processor 8 compares the password stored in the step S43 with the password set for the address data. When the two passwords are verified identical to each other, the mail display processor 7 displays text of the designated mail in the display unit 11 in step S55, and the text display process ends.

If the determination in the step S54 is that the password stored in the step S43 is different from the password set for the address data, the password authentication processor 8 requests the user an entry of password in step S56. The password authentication processor 8 then compares the password input by the user with the password set for the address data (S57), and the mail display processor 7 displays text of the designated mail only if so determined that the password input by the user is identical to the password set for the address data. This completes the text display process.

If, in the step S57, the password input by the user is determined different from the password set for the address data, an error message is displayed instead of the text (S58).

If determination in the step S52 is that the address data storage 10 does not store same address data as the acquired one, or if determination in the step S53 is that there is no password set in connection with the acquired address data, text of the designated mail is displayed without making authentication of password, and the text display process ends.

A flow of the operating process in the two way e-mail system of the fifth exemplary embodiment is put in order as follows.

The password authentication processor 8 stores a password when it displays a mail list. The mail display processor 7 directs the address data manager 9 to search through data in the address data storage 10 to find same address as a sender address data of the received mail data stored in mail data storage 6. The password authentication processor 8 compares to authenticate the password of the sender address data using the password stored when the mail list is displayed, if the sender address data is stored in the address data storage 10 and the stored sender address data has the password set thereto. Mail text in the received mail data is displayed in the display unit 11 if the two passwords match with each other. It is also possible to display text of any outbound mail in the same manner by replacing the sender address of the received mail with destination address of the outbound mail. With the above process, this embodiment can simplify the complex operation by avoiding setting of the password each time the mail text is displayed.

(Sixth Exemplary Embodiment)

Sixth exemplary embodiment of this invention will be described with reference to FIGS. 1, 2 and 17.

A structure of two way e-mail system of this sixth exemplary embodiment is analogous to that of the first exemplary embodiment, and represented by FIG. 1 and FIG. 2.

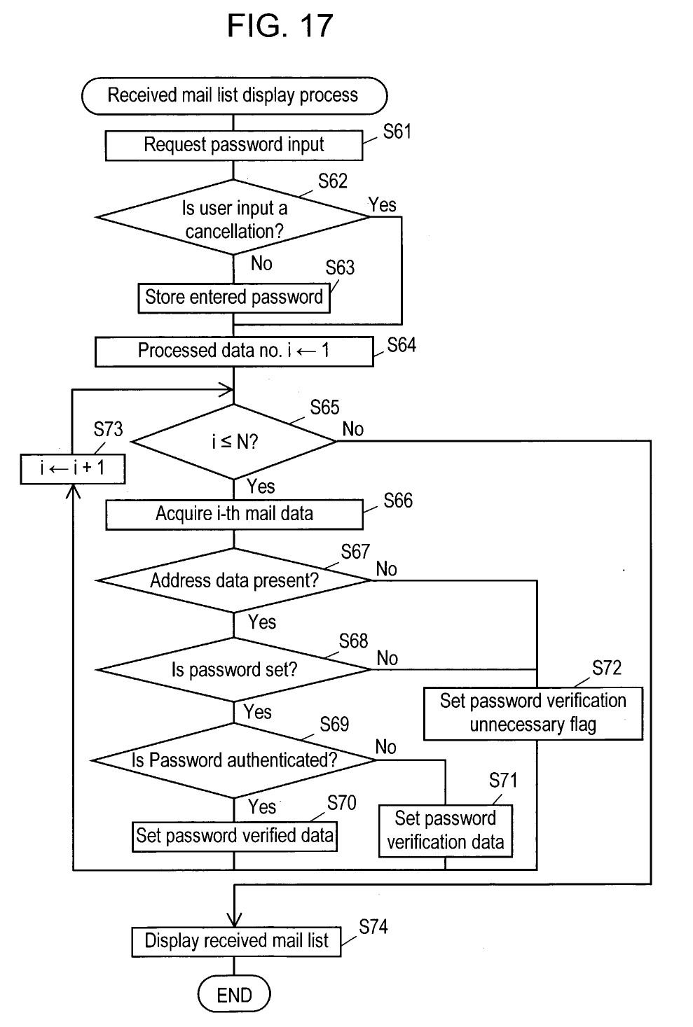

FIG. 17 is a flow chart showing an operating process for displaying received mail list with indication as to whether they are protected by a password and if the password is unlocked, in the two way e-mail system of the sixth exemplary embodiment.

In the sixth exemplary embodiment, although the following description is provided on the case of displaying a received mail list, this embodiment is also adaptable for displaying an outbound mail list in the same manner by replacing the sender address of the received mail with destination address of the outbound mail.

All received mails (or outbound mails) having addresses for which a password is set are not openable unless the password is input correctly by the user, and this function applies to all of the other exemplary embodiments.

First, mail display processor 7 directs password authentication processor 8 to request entry of a password (S61). When the password authentication processor 8 determines that operation made by the user is not a cancellation of an input (S62), it stores the password input in step S63. On the other hand, if the password authentication processor 8 determines that the operation made by the user is a cancellation of the input, it does not store the input password, and the process goes on to step S64.

In the step S64, the mail display processor 7 initializes processed data number “i” by resetting it to “1”. When it is determined in step S65 that the processed data number “i” is equal to or less than a number of received mails “N” in mail data storages 6 as referred to by the mail data manager 5, the process goes on to step S66.

In the step S66, the mail display processor 7 acquires a received mail data having data number “i” from the mail data storage 6. Next, the mail display processor 7 directs the address data manager 9 to search through the data in the address data storage 10 to find same address as the sender address of the received mail acquired in the step S66. If it is determined in step S67 that the same data as the sender address is stored in the address data storage 10, the mail display processor 7 determines presence or absence of a password set in connection with the address data (S68).

When the determination is so made in the step S68 that a password is set for the address data stored in the address data storage 10, the mail display processor 7 makes the password authentication processor 8 compare the password set for the address data with the password stored in the step S63 (S69). When the two passwords are determined identical, the mail display processor 7 sets a password verified flag (−2) as a password verification data corresponding to the received mail data acquired in the step S66 (S70).

If, in the step S69, the password set for the address data is determined different from the password stored in the step S63, the mail display processor 7 sets the address data number retrieved in the step S67 as the password verification data corresponding to the received mail data acquired in the step S66 (S71).

The mail display processor 7 sets a password verification unnecessary flag (−1) as the password verification data corresponding to the received mail data acquired in the step S66, if it determines in the step S67 that the sender address is not stored in the address data storage 10, or if it determines in the step S68 that a password is not set for the address data (S72).

After the password verification data is set, a count of one is added to the processed data number “i”, and the process goes back to the step S65 to continue the process for the remainder of data (S73).

When the processed data number “i” exceeds number of the received mails “N” in the step S65, the process goes on to step S74. In the step S74, the mail display processor 7 produces a list of the received mails with indications individually showing whether they are protected by the password and whether the password is unlocked, by referring to the password verification data set thereto, and displays it in the display unit 11. This completes the process of displaying the list of received mails.

In this sixth exemplary embodiment, as described, the password authentication processor 8 stores the password when the mail list is displayed. The mail display processor 7 directs the address data manager 9 to search through the address data in the address data storage 10 to find the sender address data of the received mail data stored in the mail data storage 6. Determination is then made as to whether there is a password set for the stored address data, when the sender address data is stored in the address data storage 10. Also, the password authentication processor 8 compares the password set for the stored address data with the stored password.

When the password is set in the stored address data, the mail display processor 7 sets any of an address data number and a password verified flag depending on a result of the authentication as the password verification data corresponding to the mail data in the mail data storage 6. If the address data is not stored in the address data storage 10, or a password is not set in the stored address data, a password verification unnecessary flag is set as the password verification data corresponding to the acquired mail data. A list of the received mails is then produced with indications for individual mails showing whether they are protected by the password and whether the password is unlocked, according to the password verification data set thereto, and the list is displayed in the display unit. In addition, it is possible to display a list of outbound mails in the same manner by replacing the sender addresses of the received mails with destination addresses of the outbound mails. The above process makes possible to display the mail list showing whether the mails are protected by the password and whether the password is unlocked for each of them individually.

(Seventh Exemplary Embodiment)

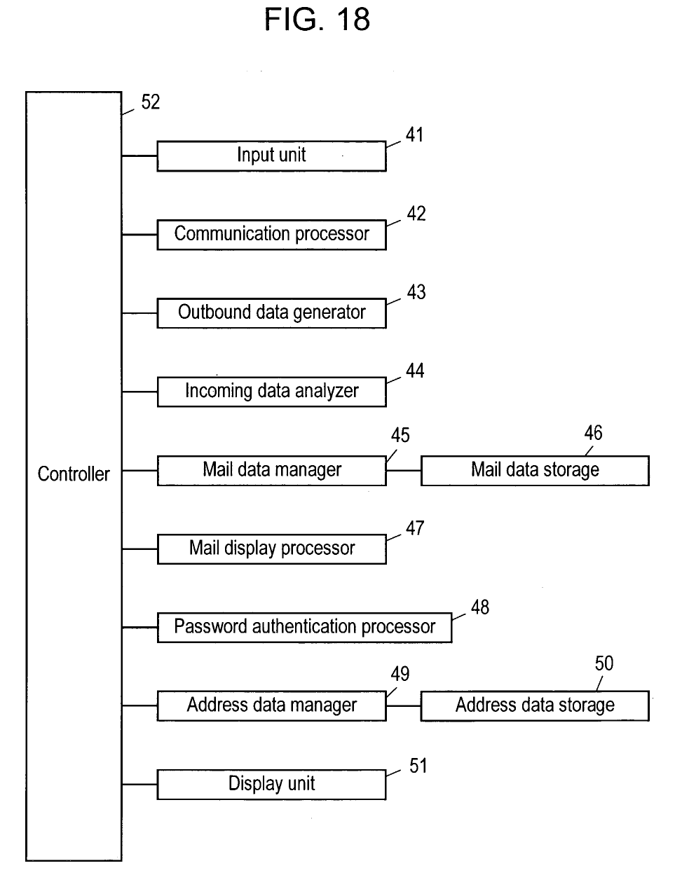

FIG. 18 is a functional block diagram showing a two way e-mail system of the seventh exemplary embodiment of this invention.

Shown here in FIG. 18 are input unit 41 for accepting a command input by a user, communication processor 42 for exchanging data with a network and the like, outbound data generator 43 for producing an outbound data according to a prescribed format when sending a mail, incoming data analyzer 44 for analyzing a received data when a mail is delivered, mail data manager 45 for managing the mail data, mail data storage 46 for storing the mail data, mail display processor 47 for controlling a process of displaying the mail, password authentication processor 48 for authenticating a password, address data manager 49 for managing data of address directory, address data storage 50 for storing data of the address directory, display unit 51 for displaying the mail data and the like, and controller 52.

As shown in FIG. 18, the controller 52 controls individual functions of communication processor 42, outbound data generator 43, incoming data analyzer 44, mail data manager 45, mail display processor 47, password authentication processor 48 and address data manager 49 as well as interrelated operation between them, while it also controls a flow of data stored in the mail data storage 46 and the address data storage 50 at the same time.

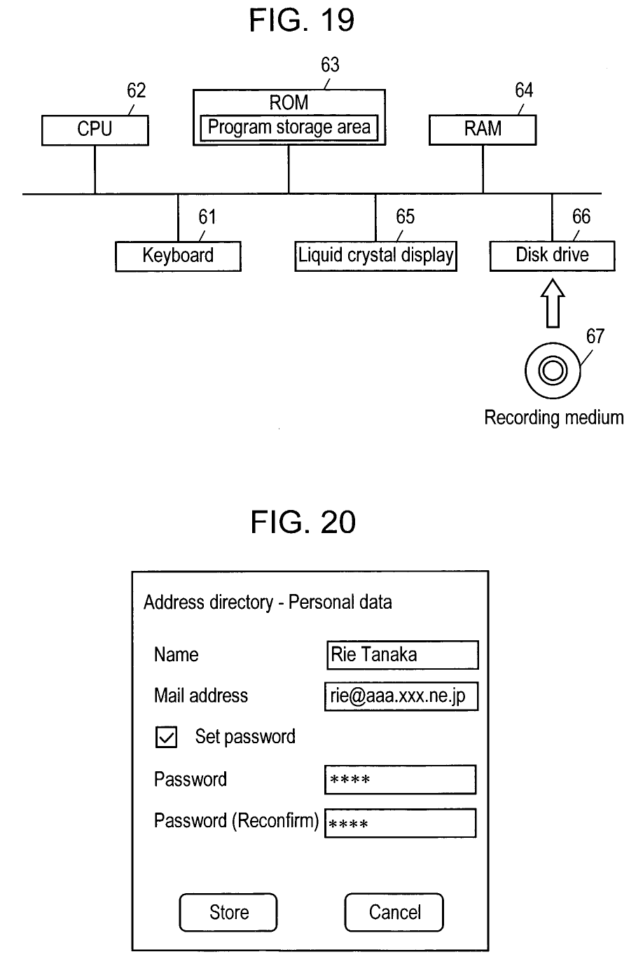

FIG. 19 is an architectural diagram of concrete hardware showing the two way e-mail system of FIG. 18. FIG. 19 shows keyboard 61, central processing unit (“CPU”) 62, read-only memory (“ROM”) 63, random access memory (“RAM”) 64, liquid crystal display 65 and disk drive 66 for reading data from recording medium 67 such as a CD-ROM or a DVD-ROM. In addition, magnetic tape media or magnetic disk media can be used for the purpose.

The input unit 41 shown in FIG. 18 is materialized with keyboard 61, and the mail data storage 46 and the address data storage 50 are materialized with RAM 64. Furthermore, the communication processor 42, outbound data generator 43, incoming data analyzer 44, mail data manager 45, mail display processor 47, password authentication processor 48, address data manager 49 and controller 52 are materialized with the CPU 62, which executes a control program stored in the ROM 63 while exchanging data with the ROM 63 and the RAM 64. In addition, the display unit 51 is materialized with liquid crystal display 65.

In this seventh exemplary embodiment, although what is shown is a configuration in which the CPU 62 performs the control function by executing the program stored in the ROM 63, it may be configured differently so that the CPU 62 executes the control program stored in the computer-readable recording medium 67 after reading it through disk drive 66 and expanding it in the RAM 64.

The two way e-mail system according to the seventh exemplary embodiment operates in a manner which will be described hereinafter.

When the two way e-mail system shown in FIG. 18 receives an incoming mail, a received data is analyzed by the incoming data analyzer 44, and mail data such as mail text and the like are stored in the mail data storage 46 under the control of the mail data manager 45.

FIG. 20 is an illustration showing an example of display screen for editing an address data, which the address data manager 49 presents on the display unit 51 for the user, when the user enters a command for address registration through the input unit 41.

All received mails (or outbound mails) having addresses to which a password is set cannot be opened unless the password is input correctly by the user. This function applies to all of the other exemplary embodiments.

When the user selects “set password” and then “store” in the address data edit screen of FIG. 20, the address data manager 49 stores a password input by the user into the address data storage 50.

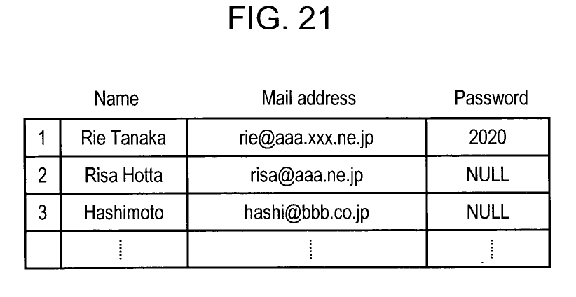

FIG. 21 is a data table showing address data to be stored in the address data storage 50. A mail address of “Rie Tanaka” shown in the table is “rie@aaa.xxx.ne.jp” and the password is “2020”. In addition, it is known that other mail addresses for “Risa Hotta” and “Hashimoto” have no password registered thereto.

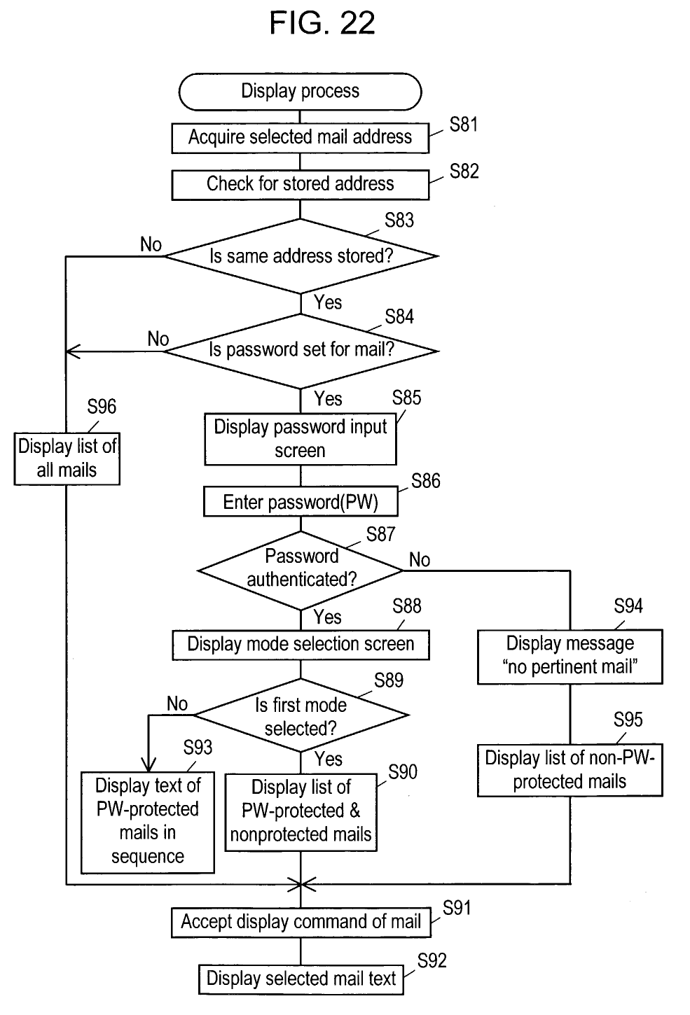

FIG. 22 shows a flow chart of operating process, when the user enters a command of “mail display” through the input unit 41.

Description is provided hereinafter on the understanding that a plural number of mails have been received and/or transmitted previously, and mail data related to these mails have already been stored in the mail data storage 46.

First, the mail display processor 47 directs the mail data manager 45 to acquire address data of desired mails (sender addresses of received mail or destination addresses if they are of outbound mails) stored in the mail data storage 46 (S81).

In step S82, the mail display processor 47 searches and checks same addresses as the acquired address data from the address data stored in the address data storage 50 by using the address data manager 49.

When determination is made in step 83 that the address data storage 50 stores at least one address among the acquired addresses, the process goes on to step S84.

In step S84, the mail display processor 47 displays a password input screen on the display unit 51 (S85), when there is one or more of the address data, for which a password is set, among those found to be successful in the check of the step S82 (i.e. matched as the same address).

When the user inputs a password through the input unit 41 in step S86, the password authentication processor 48 compares the password input by the user with the password set for the address data, which was determined in step S84 as the data having the password (S87).

When the two passwords are in agreement, the mail display processor 47 displays a selection screen for display modes in the display unit 51 (S88).

There are two kinds of display modes. A first display mode is for displaying “a mail list”. That is, the screen displays a list of mails, of which the password is in agreement, as well as those mails for which no password is set.

On the other hand, a second display mode is for displaying “mail text”, in which texts are displayed in the sequential order of arrival (i.e. ascending order from the latest arrival) of the mails of which the password is in agreement. A text of the latest mail is displayed first. When the user closes a text of the mail, a new text of another mail is displayed next. Besides, the user can puts unread/read information to the mail data being stored in the mail data storage 46 in order to distinguish those texts already displayed from the other mails. Accordingly, the user can display sequentially only texts of the unread mails by selecting them using the information recorded therewith.

When the user selects the first mode in step S89, the mail display processor 47 displays a list of the mails, of which the input password is in agreement with the password of the selected stored mail address, as well as those mails for which no password is set (S90). The mails for which no password is set in this instance means those mails that have no password set for the selected stored mail address, and/or the mails for which the selected mail address is not stored in the address data storage 50.

In step S91, when the user inputs a command for display of a text of one mail, the mail display processor 47 acquires data of the designated mail from the mail data storage 46, and displays it in the display unit 51 (S92).

If the user selects the second mode in the step S89, the mail display processor 47 displays a text of the mail received most recently among those of which the password input in the step S86 is in agreement with the password of the selected stored mail address (S93).

In step S87, if the password input by the user does not match with the password of the selected mail address stored in the address data storage 50, a massage of “no pertinent mail” is displayed in step S94. A list of mails for which no password is set are then displayed in the subsequent step S95. The mails for which no password is set in this instance means those mails that have no password set for the selected mail address stored in the address data storage 50, and/or the mails for which the selected mail address is not stored in the address data storage 50.

If there is a determination in the step S83 that the address data storage 50 does not store any data pertinent to the acquired address, or a determination in the step S84 that there is no address data that has a password set among those stored in the address data storage 50, the mail display processor 47 displays a list of all the relevant mails in step S96.

In the seventh exemplary embodiment, the mail display processor 47 requests the password authentication processor 48 to authenticate the password when selected address of mails for which display is directed by the user is stored in the address data storage 50, and the password is set for the address data. The mail display processor 47 does not display a list of the mails nor contents of the mails if a failure results in the authentication. Accordingly, this embodiment keeps certain mails inaccessible to other users who use the same mail account, and thereby realizing confidentiality protection of personal mails.

In the first through the seventh exemplary embodiments, although the descriptions have been given on the individual bases according to the embodiments, the invention can be embodied in still other forms by arranging any combination of a plurality of the above embodiments together.

Many modifications and variations of the present invention are possible in the light of the above techniques. It is therefore to be understood that within the scope of the invention the invention may be practiced otherwise than as specifically described.

What is claimed is:

1. A two way e-mail system comprising:
an outbound data generator for producing an outbound data according to a format when transmitting a mail;
an incoming data analyzer for analyzing a received data when a mail is received;
a mail data manager for managing a mail data;
a mail data storage for storing the mail data;
a mail display processor for controlling display process of the mail;
a password authentication processor for authenticating a password;
an address data manager for managing a data in address directory;
an address data storage for storing the data in the address directory;
a display unit for displaying the mail data and the like; and
a controller for controlling said outbound data generator, said incoming data analyzer, said mail data manager, said mail display processor, said password authentication processor and said address data manager, and for controlling a flow of the data stored in said mail data storage and said address data storage, wherein
said password authentication processor authenticates a password when said address data storage stores an address data for an address corresponding to a mail directed to be displayed, and said address data has said password set thereto.

2. The two way e-mail system of claim 1, wherein
said address data manager searches through address data in said address data storage and retrieves a selected address of a designated mail data to be displayed and stored in said mail data storage,
said mail display processor produces a mail list with indications showing whether or not each of mails are protected by the password by referring to a password data in said address data, and
said display unit displays said mail list.

3. The two way e-mail system of claim 1, wherein
said mail display processor determines whether said address data is stored in said address data storage, whether a group is set for said address data, and whether a password is set for a data of said group,
said password authentication processor determines identicalness of an input password in comparison with the password for said group data, and
said display unit displays said mail data.

4. The two way e-mail system of claim 1, further comprising a user data manager for managing a user data, and a user data storage for storing the user data, wherein
said controller controls said user data manager and a flow of the data stored in said user data storage,
said address data manager searches through address data in said address data storage and retrieves a selected address of a designated mail data to be displayed and being stored in said mail data storage,
said mail display processor determines whether said address data is stored in said address data storage, whether an accessible user data is set for said address data, and whether a password is set for said access user data,
said password authentication processor authenticates an input password in comparison with the password for said access user data, and
said display unit displays said mail data.

5. The two way e-mail system of claim 1, wherein
said password authentication processor stores a password when a mail list is displayed,
said address data manager searches through address data in said address data storage and retrieves a selected address of a designated mail data to be displayed and being stored in said mail data storage,
said mail display processor determines whether said address data is stored in said address data storage, and whether a password is set for said address data,
said password authentication processor authenticates the password in comparison with the password stored when said mail list is displayed, and
said display unit displays said mail data.

6. The two way e-mail system of claim 1, wherein
said password authentication processor stores a password when a mail list is displayed,
said address data manager searches through address data in said address data storage and retrieves a selected address of the mail data stored in said mail data storage,
said mail display processor determines whether or not a password is set for said address data stored in said address data storage,
said password authentication processor authenticates the password set for said address data in comparison with said stored password,
said mail display processor further sets any of an address data number and a password verified flag to said address data having the password set thereto depending on a result of the authentication as a password verification data corresponding to the mail data in said mail data storage, or said mail display processor sets a password verification unnecessary flag to said address data having no password set thereto as the password verification data corresponding to said acquired mail data, and produces a mail list with indications showing whether individual mails are protected by the password and whether the password is unlocked, according to said password verification data set thereto, and
said display unit displays said mail list.

7. A two way e-mail system comprising:
an outbound data generator for producing an outbound data according to a format when transmitting a mail;
an incoming data analyzer for analyzing a received when a mail is received;
a mail data manager for managing a mail data;
a mail data storage for storing the mail data;
a mail display processor for controlling display process of the mail;
a password authentication processor for authenticating a password;
an address data manager for managing a data in address directory;
an address data storage for storing the data in the address directory;
a display unit for displaying the mail data and the like; and
a controller for controlling said outbound data generator, said incoming data analyzer, said mail data manager, said mail display processor, said password authentication processor and said address data manager, and for controlling a flow of the data stored in said mail data storage and said address data storage, wherein
said mail display processor makes said password authentication processor authenticate a password when said address data storage stores an address data for an address corresponding to a mail directed to be displayed, and said address data has said password set thereto, and
said mail display processor displays in said display unit any one or both of a mail list including only mails having the authenticated password and contents of said mails.

8. The two way e-mail system of claim 7, wherein said mail display processor displays a text of mail without requesting input of the password when a command is given for display of the text of mail included in said mail list.

9. The two way e-mail system of claim 7, wherein said mail display processor displays in said display unit a mail not requiring authentication of the password together with the mail having the authenticated password, said mail not requiring authentication of the password being any such mail of which selected address is not stored in said address data storage, and of which address data of selected address stored in said address data storage has no password set thereto.

10. The two way e-mail system of claim 7, wherein said mail display processor is provided with function of selecting one of a first mode for displaying said mail list including a mail with the authenticated password and a second mode for displaying a text of said mail with the authenticated password.

11. The two way e-mail system of claim 7, wherein said password authentication processor is capable of authenticating a plurality of passwords when said passwords are authenticated.

12. A computer-readable recording medium carrying a program recorded therein for operating a computer to execute:
a first acquisition step for acquiring an address corresponding to a mail whose text is directed to be displayed;
a retrieval step for searching through addresses stored in an address data storage and retrieving said address;
a first determination step for determining presence or absence of a password set for said retrieved address;
an input request step for requesting input of a password;
an authentication step for authenticating said password input by a user in response to said request of input with said password set for said retrieved address data;
a first display step for displaying the text of mail when said two passwords match with each other;
a second display step for displaying an error message when said two passwords are determined not to match with each other.

13. The recording medium of claim 12, wherein said program further having a second determination step for determining whether or not the address retrieved in said retrieval step has an identification mark set thereto, and a second acquisition step for acquiring said identification mark if set for the address, and further wherein
said first determination step is for determining whether or not a password is set for data of said acquired identification mark,
said input request step is for requesting input of a password when the determination is that the password is set for the data of said acquired identification mark, and
said authentication step is for authenticating a password input by the user in response to said request of input with the password set for the data of said acquired identification mark.

14. The recording medium of claim 13, wherein said identification mark is any of a group and an accessible user.

15. A computer-readable recording medium carrying a program recorded therein for operating a computer to execute:
an input request step for requesting input of a password;
a storage step for storing the password input in response to said request of input;
an acquisition step for acquiring a selected address corresponding to a mail whose text is directed to be displayed;
a retrieval step for retrieving an address from an address data storage according to said acquired address;
a determination step for determining whether or not a password is set for said retrieved address;
a step for authenticating said stored password with the password set for said retrieved address;
a first display step for displaying text of the mail when said two passwords match with each other as a result of the authentication;
a step for requesting input of a password when said two passwords does not match as a result of the authentication;
a step for authenticating the password input by a user with the password set for said address data; and
a second display step for displaying an error message.

16. A computer-readable recording medium carrying a program recorded therein for operating a computer to execute:
an input request step for requesting input of a password;
a storage step for storing the password input in response to said request of input;
a data number confirmation step for confirming a number of processed data;
an acquisition step for acquiring a mail data in a mail data storage;
a retrieval step for retrieving an address data in an address data storage according to an address data of said acquired mail data;
a password determination step for determining whether or not a password is set for said retrieved address data;
an authentication step for authenticating said stored password with the password set for said retrieved address data when the password is set for said retrieved address data;
a number setting step for setting any of an address data number and a password verified flag depending on a result of said authentication, as a password verification data corresponding to said acquired mail data;
a flag setting step for setting a password verification unnecessary flag as the password verification data corresponding to said acquired mail data when no password is set for said retrieved address data; and
a production and display step for producing and displaying a mail list with indications showing whether individual mails are protected by the password and whether the password is unlocked, according to said password verification data set thereto.

17. A computer-readable recording medium carrying a program recorded therein for operating a computer to execute:
a data number confirmation step for confirming a number of processed data;
an acquisition step for acquiring a mail data in a mail data storage;
a retrieval step for retrieving an address data in an address data storage according to an address data of said acquired mail data;
a password determination step for determining presence or absence of a password set for said retrieved address data;
a number setting step for setting an address data number as a password verification data corresponding to said acquired mail data;
a flag setting step for setting a password verification unnecessary flag as the password verification data corresponding to said acquired mail data; and
a production and display step for producing and displaying a mail list with indications showing whether individual mails are protected by the password and whether the password is unlocked, according to said password verification data set thereto.
